(19) United States
(12) Patent Application Publication
(10) Pub. No.: US 2026/0323642 A1
(43) Pub. Date: Oct. 15, 2026

(54) HIGH-THROUGHPUT CONTROL FOR ULTRA-HIGH RELIABILITY

(71) Applicant: HUAWEI TECHNOLOGIES CO., LTD., SHENZHEN (CN)

(72) Inventors: Sara NOROUZI, Kanata (CA); Osama ABOUL-MAGD, Kanata (CA); Yan XIN, Kanata (CA); Kwok Shum AU, Kanata (CA); Jung Hoon SUH, Kanata (CA); Mahmoud HASABELNABY, Kanata (CA); Abdalla Mohamed Abdelaziz Mahmoud HUSSEIN, Kanata (CA)

(73) Assignee: HUAWEI TECHNOLOGIES CO., LTD., SHENZHEN (CN)

(21) Appl. No.: 19/175,642

(22) Filed: Apr. 10, 2025

(51) Int. Cl. H04W 72/20; H04L 1/00

(52) U.S. Cl. CPC H04W 72/20; H04L 1/003

(57) ABSTRACT

Methods and apparatus are disclosed for providing ultra-high reliability (UHR) link adaptation. To enable UHR link adaptation between network devices of a Wi-Fi network, parameters for the link adaptation are indicated in the high-throughput (HT) control field of a medium access control header associated with data frames. A control identifier for the HT control field can be set to indicate a UHR link adaptation for control information provided in the HT control field. In some embodiments, the parameters for UHR link adaptation may be provided through a plurality of data frames, each having a respective HT control field that provides some UHR link adaptation parameters. Embodiments can facilitate provision of parameters for new modulation and coding systems, unequal modulation, and distributed resource units.

### CROSS-REFERENCE TO RELATED APPLICATIONS

This is the first application filed for the present invention.

### FIELD OF THE INVENTION

The present application pertains to communication links and in particular to methods and apparatus for link adaptation.

### BACKGROUND

In a Wi-Fi network, link adaptation (LA) is used to dynamically adjust transmission parameters to match the current conditions of wireless channels in the network. These adjustments can improve the reliability, spectral efficiency, and latency of the network. LA parameters can be carried in quality-of-service (QoS), data, and management frames by the high-throughput control (HTC) field present in the medium access control (MAC) header of these frames, which can be activated by the +HTC subfield of the header's control field. In particular, the A-control subfield of the HT control field may be used to provide the LA parameters when the field's control identification (ID) field is set to a high-efficiency (HE) or high-throughput (HT) link adaptation value. However, because of the limited size of the A-control subfield, this approach cannot accommodate new LA features, especially those needed for ultra-high reliability (UHR) LA, such as unequal modulation (UEQM), distributed resource unit (DRU), and new modulation and coding system (MCS) features.

Therefore, there is a need for methods and apparatus for UHR LA that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present disclosure is to provide methods and apparatus for ultra-high reliability link adaptation.

A first aspect of the present disclosure is to provide a method for providing ultra-high reliability link adaptation (ULA) parameters from a first network device to a second network device in an IEEE 802.11 wireless communication network. The method may be performed at the first network device and may comprise preparing a physical protocol data unit (PPDU) having a medium access control (MAC) header including a high-throughput (HT) control field. The HT control field may include a control subfield providing a control identifier (ID) and control information. Each of the control ID and control information may include a respective plurality of bits. The method may further comprise: setting the respective plurality of bits of the control ID to indicate, for the control information, a ULA type; setting five consecutive bits from among the respective plurality of bits of the control information to indicate an ultra-high reliability modulation and coding system; and sending, through the wireless communication network, the PPDU to the second network device.

In some embodiments of the first aspect, the respective plurality of bits of the control ID may consist of four bits and may be set to one of 1011, 1100, 1101, and 1110.

In some embodiments of the first aspect, the respective plurality of bits of the control information may consist of 26 bits. In these embodiments, the method may further comprise setting, from among the 26 bits of the control information: a first one bit to indicate an unsolicited management frame block (MFB); a second one bit to indicate a management request/uplink extremely high throughput trigger-based PPDU MFB; a first three bits to indicate a number of spatial streams; eight bits to indicate a resource unit allocation; a third one bit to indicate a primary/secondary 160 MHz channel; a second three bits to indicate a bandwidth; a third three bits to indicate one or more MAC sequence control information/partial PPDU parameters; and a fourth one bit to indicate transmission beamforming.

In some embodiments of the first aspect, the respective plurality of bits of the control ID may be set to indicate, for the control information, the ULA type and to further indicate a subsequent ULA expansion. In these embodiments, the method may further comprise: preparing a further PPDU having a further MAC header including a further HT control field, with the further HT control field including a further control subfield providing a further control ID and further control information, and with each of the further control ID and further control information including a respective plurality of bits; setting the respective plurality of bits of the further control ID to indicate, for the further control information, a ULA expansion type; setting each of one or more groups of bits from among the respective plurality of bits of the further control information to indicate a respective further ULA parameter; and sending, through the wireless communication network, the further PPDU to the second network device. In some embodiments, each of the ULA type and the ULA expansion type may correspond to a same value. In some of these embodiments, the same value may be one of 11, 12, 13, and 14, and each of the respective pluralities of bits of the control ID and the further control ID may consist of four bits and may be set, in accordance with the same value, to one of 1011, 1100, 1101, and 1110. In some other embodiments, each of the ULA type and the ULA expansion type may correspond to different respective values. In some other embodiments, the respective plurality of bits of the control ID may consist of four bits and may be set to one of 1011, 1100, 1101, and 1110, and the respective plurality of bits of the further control ID may consist of a further four bits and may be set to 1111. In some embodiments, the method may further comprise: setting, for the PPDU, at least one bit from among the respective plurality of bits of the control information to indicate that the control information is initial control information; and setting, for the further PPDU, at least one bit from among the respective plurality of bits of the further control information to indicate that the further control information is subsequent control information. In some embodiments, each at least one further ULA parameter may be one of: an unequal modulation (UEQM) indicator; a UEQM pattern; a distributed resource unit indicator; a distribution bandwidth; a number of spatial streams for multi-user multiple input multiple output (MU-MIMO) operation; and a modulation and coding system for MU-MIMO. In some embodiments, the method may further comprise setting, for the further PPDU, at least one bit from among the respective plurality of bits of the further control information to indicate, for the further control information, a ULA expansion sub-type.

A second aspect of the present disclosure is to provide another method for providing ULA parameters from a first network device to a second network device in an IEEE 802.11 wireless communication network. The method may be performed at the first network device and may comprise preparing a first PPDU and a second PPDU each having a respective MAC header including a respective HT control field. Each HT control field may include a respective control subfield providing a respective control ID and respective control information. Each control ID and each control information may include a respective plurality of bits. The method may further comprise: setting, for the first PPDU, the respective plurality of bits of the respective control ID to indicate, for the respective control information, a ULA type and to further indicate a ULA expansion; setting, for the second PPDU, the respective plurality of bits of the respective control ID to indicate, for the respective control information, a ULA expansion type; setting, for each of the first PPDU and the second PPDU, each of one or more groups of bits from among the respective plurality of bits of the respective control information to indicate a respective ULA parameter; and sending, through the wireless communication network, the first PPDU and the second PPDU to the second network device.

In some embodiments of the second aspect, each of the ULA type and the ULA expansion type may correspond to a same value. In some of these embodiments, the same value may be one of 11, 12, 13, and 14, and each of the respective pluralities of bits of the control ID and the further control ID may consist of four bits and may be set, in accordance with the same value, to one of 1011, 1100, 1101, and 1110. In some other embodiments, each of the ULA type and the ULA expansion type may correspond to different respective values. In some embodiments, the respective plurality of bits of the control ID may consist of four bits and may be set to one of 1011, 1100, 1101, and 1110, and the respective plurality of bits of the further control ID may consist of a further four bits and may be set to 1111.

In some embodiments of the second aspect, the method may further comprise: setting, for the PPDU, at least one bit from among the respective plurality of bits of the control information to indicate that the control information is initial control information; and setting, for the further PPDU, at least one bit from among the respective plurality of bits of the further control information to indicate that the further control information is subsequent control information.

In some embodiments of the second aspect, each at least one further ULA parameter may be one of: an UEQM indicator; a UEQM pattern; a distributed resource unit indicator; a distribution bandwidth; a number of spatial streams for MU-MIMO operation; and a modulation and coding system for MU-MIMO.

In some embodiments of the second aspect, the method may further comprise setting, for the further PPDU, at least one bit from among the respective plurality of bits of the further control information to indicate, for the further control information, a ULA expansion sub-type.

A third aspect of the present disclosure is to provide another method for providing one or more ULA parameters from a first network device to a second network device in an IEEE 802.11 wireless communication network. The method may be performed at the first network device and may comprise preparing a PPDU having a MAC header including a HT control field. The HT control field may include a control subfield providing a control ID and control information. Each of the control ID and control information may include a respective plurality of bits. The method may further comprise: performing a first set of actions when the one or more ULA parameters excludes each of one or more ULA expansion parameters, and performing a second set of action when the one or more ULA parameters includes at least one of the one or more ULA expansion parameters. The first set of actions may include: setting the respective plurality of bits of the control ID to indicate, for the control information, a ULA without expansion type; setting at least one bit from among the respective plurality of bits of the control information to indicate the one or more ULA parameters; and sending, through the wireless communication network, the PPDU to the second network device. The second set of actions may include: preparing a further PPDU having a further MAC header including a further HT control field, the further HT control field including a further control subfield providing a further control ID and further control information, each of the further control ID and further control information including a respective plurality of bits; setting the respective plurality of bits of the control ID to indicate, for the control information, a ULA with expansion type, and the respective plurality of bits of the further control ID to indicate, for the further control information, a ULA expansion type; setting at least one bit of each of the respective plurality of bits of the control information and the further control to indicate the one or more ULA parameters; and sending, through the wireless communication network, the PPDU and the further PPDU to the second network device.

In some embodiments of the third aspect, the one or more ULA expansion parameters may include at least one of an unequal modulation parameter and a distributed resource unit parameter.

In some embodiments of the third aspect, each of the ULA with expansion type and the ULA without expansion type may correspond to a different respective value. In some of these embodiments, each of the ULA without expansion type and the ULA expansion type may correspond to a different respective value. In some of these embodiments, each of the respective pluralities of bits of the control ID and the further control ID may consist of a respective four bits. In these embodiments, the respective plurality of bits of the control ID may be set to 1100 when the one or more ULA parameters excludes each of the one or more ULA expansion parameters, and 1101 when the one or more ULA parameters includes the at least one of the one or more ULA expansion parameters, and the respective plurality of bits of the further control ID may be set to 1111. In some embodiments, the respective plurality of bits of the control ID and the respective plurality of bits of the further control ID may differ by only one bit.

A fourth aspect of the present disclosure is to provide a method for reporting unavailability from a first network device to a second network device in an IEEE 802.11 wireless communication network. The method may be performed at the first network device and may comprise preparing a PPDU having a MAC header including a HT control field. The HT control field may include a control subfield providing a control ID and control information. Each of the control ID and control information may include a respective plurality of bits. The method may further comprise: setting the respective plurality of bits of the control ID to indicate, for the control information, an unavailability report type; setting each of one or more groups of bits from among the respective plurality of bits of the control information to indicate a respective unavailability parameter; and sending, through the wireless communication network, the PPDU to the second network device.

In some embodiments of the fourth aspect, at least one unavailability parameter may be one of an unavailability start time and an unavailability duration. In some embodiments, the respective plurality of bits of the control ID may consist of four bits and may be set to one of 1011, 1100, 1101, and 1110.

A fifth aspect of the present disclosure is to provide a device configured to perform any of the methods disclosed herein.

A sixth aspect of the present disclosure is to provide a processor, configured to execute instructions to cause a device to perform any of the methods disclosed herein.

Embodiments of the first aspect may facilitate ULA by enabling distribution of ULA parameters between network devices. This may include enabling provision of UEQM, distributed resource unit, and new MCS parameters.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 shows an example of a physical layer protocol data unit (PPDU) with a MAC header.

FIG. 2 shows an example of a format for control information in an HT control field.

FIG. 3 shows a flowchart for a method for providing UHR LA parameters, in accordance with embodiments of the present disclosure.

FIG. 4 shows an example of a format for control information that includes a UHR LA parameter, in accordance with an embodiment of the present disclosure.

FIG. 5A shows an example of a format for control information of a first PPDU that provides UHR LA parameters, in accordance with an embodiment of the present disclosure.

FIG. 5B shows an example of a format for control information of a second PDDU that provides UHR LA parameters, in accordance with an embodiment of the present disclosure.

FIG. 6A shows an example of a format for an HT control field that provides UHR LA parameters without an expansion, in accordance with an embodiment of the present disclosure.

FIG. 6B shows an example of a format for an HT control field that provides UHR LA parameters with an expansion, in accordance with an embodiment of the present disclosure.

FIG. 7 shows a schematic of an apparatus for UHR link adaptation according to embodiments of the present disclosure.

FIG. 8 shows a schematic of an embodiment of an electronic device that may implement at least part of the methods and features of the present disclosure.

It will be noted that throughout the appended drawings, like features are identified by like reference numerals.

### DETAILED DESCRIPTION

Embodiments of the present disclosure are generally directed towards methods and apparatus for providing UHR LA parameters between devices of a Wi-Fi communication network. The Wi-Fi communication network may operate according to IEEE 802.11 protocols and may include a plurality of network devices connected by wireless links. Network devices may include, for example, network stations, user equipment, and access points, and may be configured to transmit and/or receive data wirelessly. The communication network may further be a multiple-input multiple output (MIMO) system wherein multiple antennae at each of a transmitter network device and a receiver network device may be able to transmit data over a plurality of spatial streams. In embodiments, UHR LA parameters may be provided from one network device to another by using the HT control field belonging to the MAC header of physical layer protocol data units (PPDUs) sent from the one network device. In embodiments, a control identifier (ID) of the HT control field may be set to indicate that control information also included in the HT control field provides UHR LA parameters. In some embodiments, the UHR LA parameters may be provided among the control information of a plurality of PPDUs sent from the one network device. In these embodiments, the initial PPDU may indicate by its respective control ID that a subsequent PPDU will be forthcoming and will provide a UHR LA expansion.

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof.

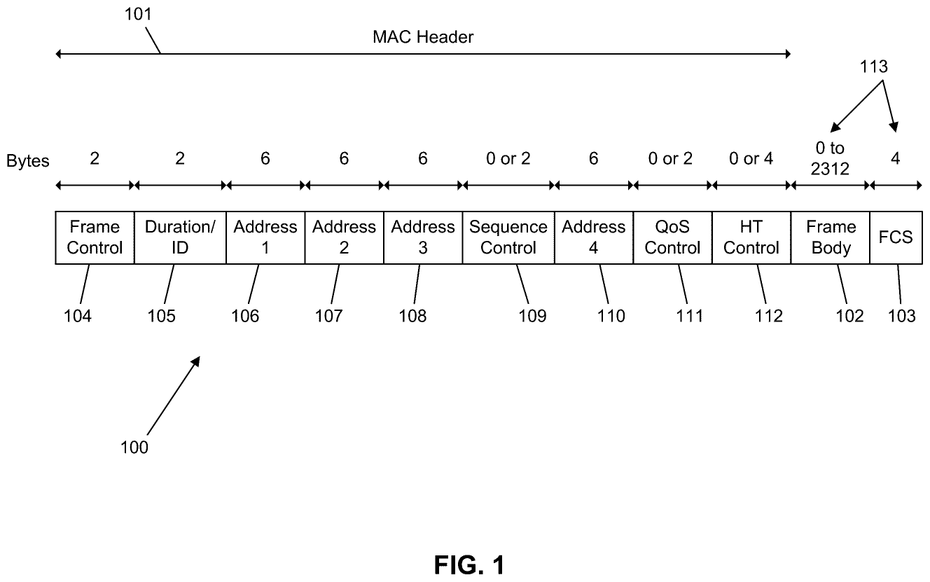

FIG. 1 shows an example, typical of the prior art, of a MAC frame 100 and MAC header 101 for a PPDU. The MAC frame 100 may be configured according to IEEE 802.11 protocols. The MAC frame 100 may, for example, be a control wrapper frame, a QoS data frame, or a management frame. The MAC frame 100 may comprise the MAC header 101 as well as a frame body 102 and a frame check sum (FCS) field 103. The MAC header 101 may comprise fields for: frame control 104, duration or identification 105, a first address 106, a second address 107, a third address 108, sequence control 109, a fourth address 110, QoS control 111, and HT control 112. Each field of the MAC frame 100 may include a respective one or more bytes 113. Inclusion of the HT control field 112 may be determined by an HTC subfield of the frame control field 104. When included, the HT control field 112 may encompass four bytes. Table 1 below shows the format, by subfields, for three different variants of an HT control field 112 transmitted by a non-control mode management group (non-CMMG) station: a HT variant, a very-high-throughput (VHT) variant, and a high-efficiency/extremely-high-throughput (HE/EHT) variant. Subfields in Table 1 are indicated by their bit positions (e.g., B0, B1, B2 . . . ) and may include a HT control middle subfield, a VHT control middle subfield, an autocorrelation (AC) constraint subfield, a response delay grant (RDG)/more PPDU subfield, and an A-control subfield.

TABLE 1
Subfields for HT control field 112 variants.

| Variant | B0 | B1 | B2 to B29 | B30 | B31 |
|---|---|---|---|---|---|
| HT | 0 | HT Control Middle | | AC | RDG/More |
| | | | | Constraint | PPDU |
| VHT | 1 | 0 | VHT Control | AC | RDG/More |
| | | | Middle | Constraint | PPDU |

| | | | |
|---|---|---|---|
| HE/EHT | 1 | 1 | A-Control |

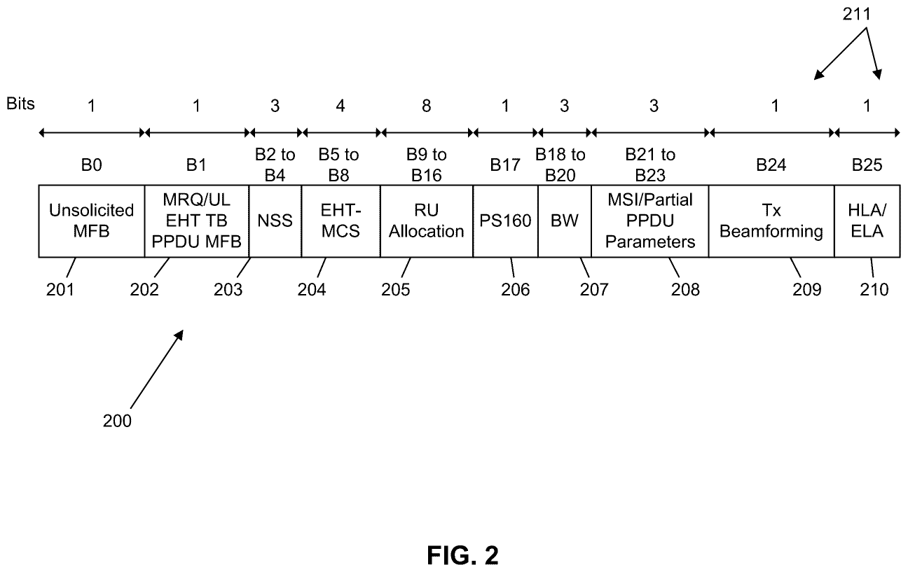

In HE/EHT variants, the HT control field 112 may be used to include LA parameters. The A-control subfield may span 30 bits of the four bytes of the HT control field 112, of which four bits may be used to indicate a control identifier (ID) and the remaining 26 bits may be used for control information. The A-control subfield may be referred to herein generally as a ‘control subfield’. Table 2 below shows the different values that the control ID may take and the associated meaning of each control ID. Each control ID may indicate a respective type for the control information included in the HT control field 112. Twelve of the values indicate currently defined control fields while another four values have been reserved for future indications. For some control IDs, only a portion of the 26 bits of control information may be needed. In these cases, the remaining bits may be padded with zeros. A control ID of value two (i.e., “0010”) indicates an HE LA (HLA)/EHT LA (ELA) control field and the remaining 26 bits are allocated for control information. FIG. 2 shows an example, typical of the prior art, of a schematic for the control information 200 with an ELA control ID defined. The control information 200 may comprise further subfields for: an unsolicited management frame block (MFB) 201, a management request (MRQ)/uplink (UL) EHT trigger-based (TB) PPDU MFB 202, a number of spatial streams (NSS) 203, an EHT-MCS 204, resource unit (RU) allocation 205, a primary/secondary 160 MHz (PS160) subfield 206, bandwidth (BW) 207, MAC sequence control information (MSI)/partial PPDU parameters 208, transmitter (Tx) beamforming 209, and HLA/ELA 210. Each of these subfields may include one or more bits 211, at the positions shown in FIG. 2 (e.g., B0, B1, B2 . . . ).

TABLE 2
Control ID values and meanings.

| | | Length of |
|---|---|---|
| | | the Control |
| Control ID | | Information |
| Value | Meaning | Subfield (bits) |
| 0 | Triggered Response Scheduling (TRS) | 26 |
| 1 | Operating Mode (OM) | 12 |
| 2 | HE LA (HLA)/ EHT LA (ELA) | 26 |
| 3 | Buffer Status Report (BSR) | 26 |
| 4 | UL Power Headroom (UPH) | 8 |
| 5 | Bandwidth Query Report (BQR) | 10 |
| 6 | Command and Status (CAS) | 8 |
| 7 | EHT Operating Mode (EHT OM) | 6 |
| 8 | Single Response Scheduling (SRS) | 10 |
| 9 | Access Point Assistance Request (AAR) | 20 |
| 10 | Multi-link Power Management (MLPM) | TBD |
| 11-14 | Reserved | |
| 15 | Ones Need Expansion Surely (ONES) | 26 |

To communicate LA parameters, namely HLA or ELA parameters, between network devices, such as between a transmitter and a receiver, one network device may send the LA parameters to another by sending a PPDU including a MAC header 101 with an HT control field 112 having its control ID set to “0010” or a value of two. The LA parameters, such as EHT-MCS 204, may be included in the control information 200 of the HT control field 112. The LA parameters may be sent in response to a request for feedback on transmissions to the one network device. For example, the LA parameters may be based on an evaluation of packets received by the one network device or the characteristics of the network channel connecting the one network device to the other. This approach to providing LA parameters is, however, incompatible with UHR LA. In particular, the format for the control information 200 shown in FIG. 2 does not provide sufficient space for features of UHR LA, such as new MCS, UEQM, and DRU parameters.

Embodiments of the present disclosure are generally directed to providing methods and apparatus for communicating UHR LA parameters between network devices. In embodiments, the reserved control ID values (i.e., values 11 to 14) and the ONES control ID value (i.e., 15) may be used for communicating UHR LA parameters. In addition, in some embodiments, more than one PPDU packet may be used to communicate the UHR LA parameters.

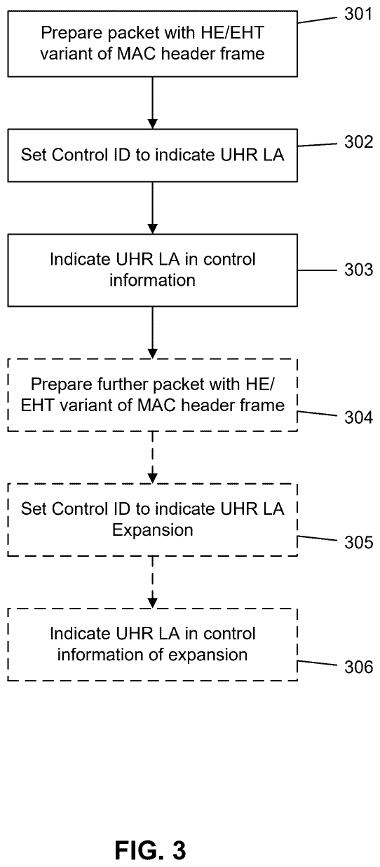

FIG. 3 shows a flowchart of an embodiment of a method for providing UHR LA parameters from a first network device to a second network device through a Wi-Fi communication network, in accordance with embodiments of the present disclosure. The Wi-Fi communication network may operate according to IEEE 802.11 protocols and may include a plurality of network devices connected by wireless links. Network devices may include, for example, network stations, user equipment, and access points, and may be configured to transmit and/or receive data wirelessly. The communication network may further be a multiple-input multiple output (MIMO) system such as a single user (SU) MIMO system, wherein multiple antennae at each of a transmitter network device and a receiver network device may be able to transmit data over a plurality of spatial streams. The MIMO system may further be a multi-user (MU) MIMO system, which may include communication over a plurality of spatial streams between a transmitter network device or a receiver network device and a plurality of other network devices. At action 301 of FIG. 3, a PPDU packet having a MAC header 101 may be prepared for transmission from a first network device to a second network device. The MAC header 101 may have a plurality of fields, including an HT control field, which may in turn have a control sub-field, and particularly, an A-control subfield. The A-control sub-field may include a control ID and control information. Each of the control ID and the control information 200 may include a plurality of bits. At action 302, the respective plurality of bits of the control ID may be set to indicate a UHR LA type for the control information 200. For example, the control ID may be set to any of values 11 to 14 (i.e., “1011”, “1100”, “1101”, or “1110”), which may be assigned to representing a UHR LA type instead of being reserved. At action 303, one or more bits in the plurality of bits of the control information 200 may be used to indicate one or more UHR LA parameters. For example, five bits may be set to indicate a UHR MCS. In this case, the control information may resemble the format shown in FIG. 2 but with a subfield comprising five bits for UHR MCS that is formed from the EHT-MCS subfield 204 and the HLA/ELA subfield 210.

In some embodiments, more than one PPDU packet may be needed to communicate all the UHR LA parameters. In these embodiments, at action 304, a further PPDU packet having a MAC header 101 may be prepared for transmission from the first network device to the second network device. The further PPDU packet (i.e., the second PPDU) may be configured similarly to the PPDU packet prepared at action 301 (i.e., the first PPDU) and may provide a ‘UHR LA expansion’. In these embodiments, the first PPDU may further have the respective plurality of bits of its control ID be set to indicate the subsequent, second PPDU in addition to indicating the UHR LA type for its respective control information 200.

When a second PPDU is prepared, at action 305, the respective plurality of bits of the control ID of the second PPDU may be set to indicate a UHR LA expansion type for its respective control information 200. In some embodiments, each of the UHR LA type and the UHR LA expansion type may correspond to a same control ID value (e.g., from among values 11 to 14). In these embodiments, one or more respective bits of the respective control information of each of the first and second PPDUs may be used to indicate which is the first PPDU and which is the second PPDU. In some other embodiments, different control ID values may be used to indicate the UHR LA type and the UHR LA expansion type (e.g., any two values from among values 11 to 14, or one value from among values 11 to 14 and one of value 15). In some other embodiments, different control values may be used to indicate whether the UHR LA expansion is needed and is forthcoming. In these embodiments, one control ID value (e.g., from among values 11 to 14) may be used to indicate that no UHR LA expansion is needed and that an expansion will not be forthcoming (i.e., to indicate a ‘UHR LA without expansion type’), while another control ID value (e.g., another value from among values 11 to 14) may be used to indicate that a UHR LA expansion is needed and will be forthcoming (i.e., to indicate a ‘UHR LA with expansion type’). In other words, different control IDs may be used to indicate the UHR LA type and the UHR LA type with a subsequent UHR LA expansion. In these embodiments, the different control IDs may be selected to have values that differ by only one bit (e.g., “1100” and “1101”). In some embodiments, the need for a UHR LA expansion may be based on whether at least one UHR LA expansion parameter is included in the set of UHR LA parameters to be transmitted from the first network device to the second network device. The UHR LA expansion parameters may be UHR LA parameters pre-designated for transmission in a UHR LA expansion.

At action 306, each of one or more groups of bits from among the respective plurality of bits of the control information of the second PPDU may be set to indicate a respective UHR LA parameter. Each UHR LA parameter in this UHR LA expansion (i.e., the UHR LA expansion parameters) may, for example, be one of a UHR MCS, a UEQM indicator, a UEQM pattern, a DRU indicator, a DRU bandwidth, a number of spatial streams for MU-MIMO, and an MCS for MU-MIMO. In some embodiments, one or more bits from among the respective plurality of bits of the control information of the second PPDU may be set to indicate a sub-type for the UHR LA expansion. The UHR LA expansion subtype may indicate to the second network device which UHR LA parameters are included in the control information and the format thereof.

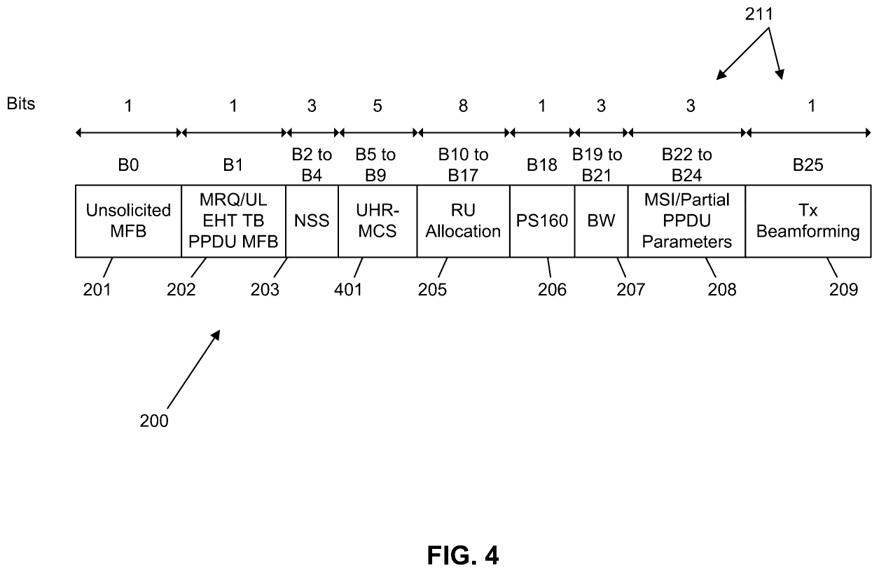

FIG. 4 shows an example of a schematic for the control information 200 with a UHR LA type defined by the control ID, in accordance with an embodiment of the present disclosure. Similar to the control information 200 shown in FIG. 2, the control information 200 shown in FIG. 4 may comprise subfields for: an unsolicited MFB 201, a MRQ/UL EHT TB PPDU MFB 202, a NSS 203, a RU allocation 205, a PS160 206, a BW 207, MSI/partial PPDU parameters 208, and Tx beamforming 209. Unlike the control information 200 shown in FIG. 2, the control information in FIG. 4 may further comprise a subfield for a UHR MCS 401 instead of the EHT-MCS 204 and HLA/ELA 210 subfields. Each subfield of the control information 200 may include one or more bits 211, at the positions shown in FIG. 4 (e.g., B0, B1, B2 . . . ). Unlike the EHT-MCS subfield 204, the UHR MCS 401 subfield may comprise five bits, which may provide twice as many options for the MCS. The format for the control information 200 shown in FIG. 4 may be assigned, for example, to any of control IDs of value 11 to 14. This format may further be used for a first PPDU to be followed by a second PPDU that provides a UHR LA expansion.

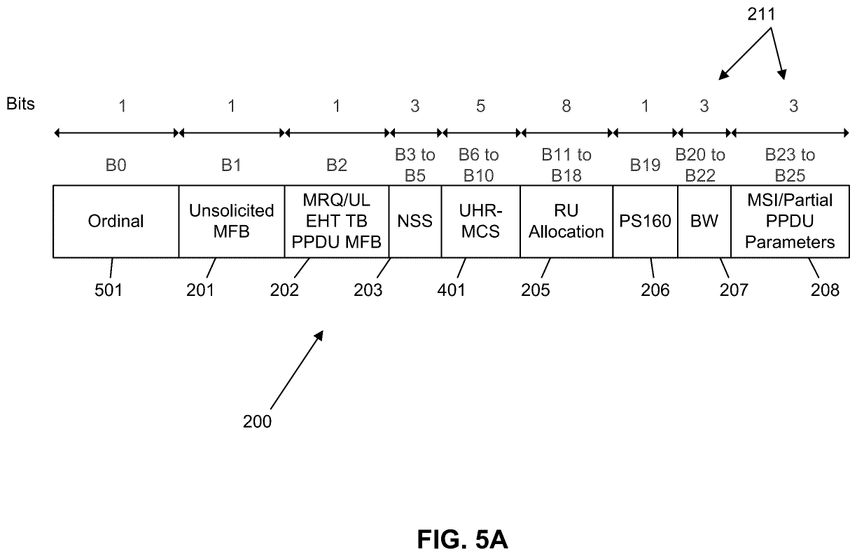

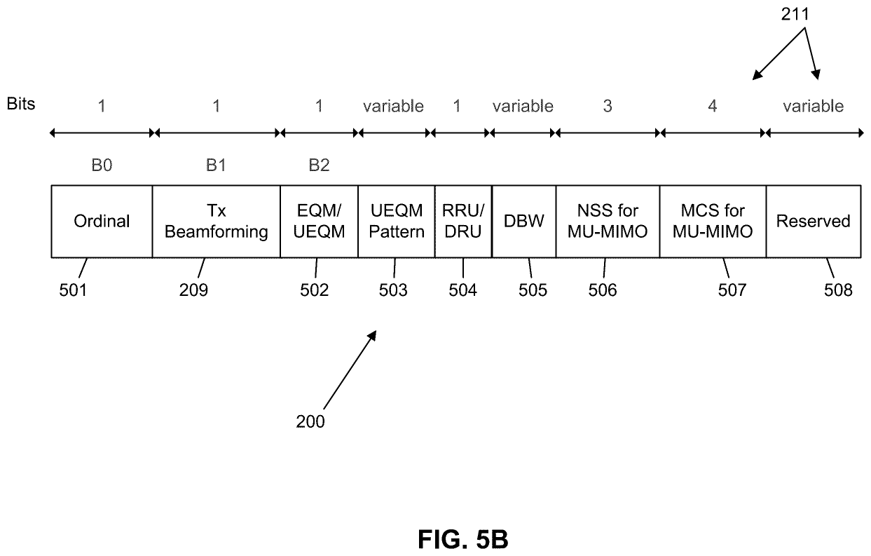

FIGS. 5A and 5B show example schematics for expanded control information 200 between a first PPDU and a second PPDU, respectively, in accordance with an embodiment of the present disclosure. The control ID for the first PPDU may be set to indicate a UHR LA type for the control information of the first PPDU and to further indicate that the subsequent, second PPDU is forthcoming. The control ID for the second PPDU may be set to indicate a UHR LA expansion type for the second PPDU. Both of the UHR LA type and the UHR LA expansion type may correspond to a same value, e.g. 12 or any other value of 11 to 14. In this case, as shown in FIGS. 5A and 5B, the control information of each of the first PPDU and the second PPDU may include a respective subfield including at least one respective bit that indicates whether that control information is initial control information (i.e., belonging to the first PPDU) or subsequent control information (i.e., belonging to the second PPDU). This subfield may be referred to as an ordinal subfield. FIG. 5A shows the control information for the first PPDU including subfields for: an ordinal 501, an unsolicited MFB 502, a MRQ/UL EHT TB PPDU MFB, a NSS 203, a UHR-MCS 401, a RU allocation 205, a PS160 206, a BW 207, and MSI/partial PPDU parameters 208. FIG. 5B shows the control information for the first PPDU including subfields for: an ordinal 501, Tx beamforming 209, an indication of equal modulation (EQM) or UEQM 502, a pattern for UEQM 503, an indication of regular resource unit (RRU) or DRU allocation 504, a distribution bandwidth (DBW) 505, a NSS for MU-MIMO 506, a MCS for MU-MUMO 507, and reserved bits 508. Each subfield of the control information 200 may include one or more bits 211, at the positions shown in FIGS. 5A and 5B (e.g., B0, B1, B2 . . . ).

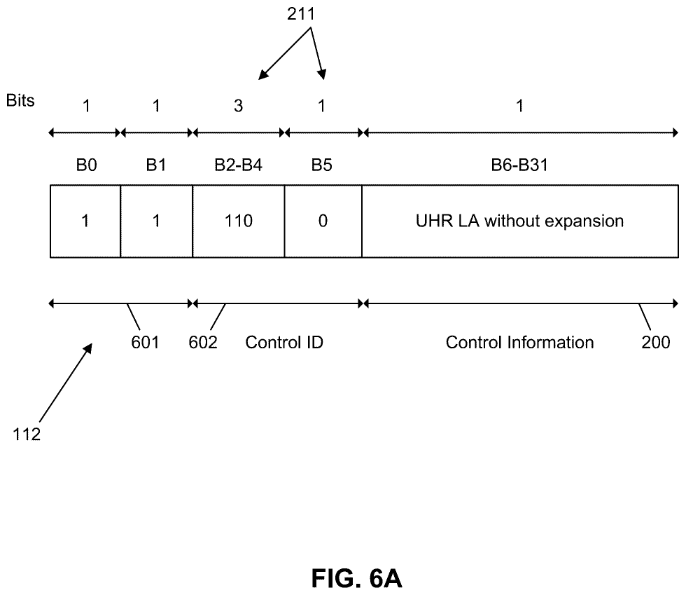

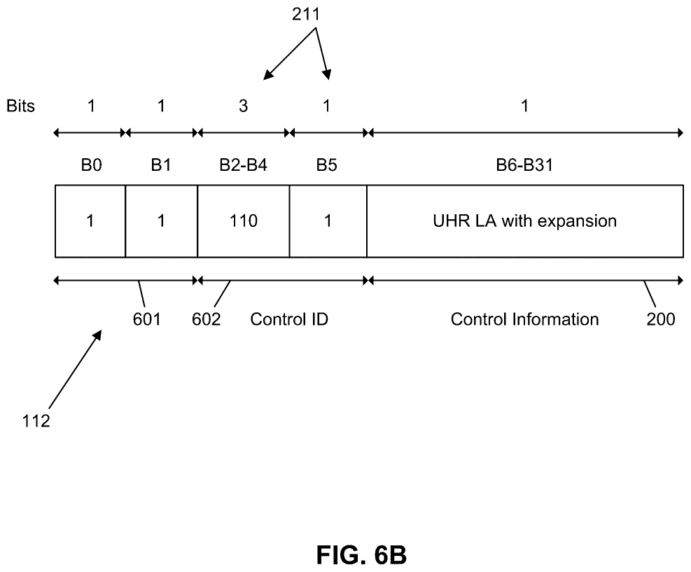

FIGS. 6A and 6B show example schematics for the HT control field 112 when a UHR LA expansion is and isn't needed, respectively, in accordance with an embodiment of the present disclosure. FIG. 6A shows the HT control field 112 including two bits (i.e., B0 and B1) for indicating the HT control field 112 as an HE/EHT variant 601 (i.e., “11”), four bits (i.e., B2 to B5) for a control ID 602 to indicate a UHR LA without expansion type for the control information 200 (e.g., 1100), and the control information 200. Meanwhile, FIG. 6B shows the HT control field 112 including two bits (i.e., B0 and B1) for indicating the HT control field 112 as an HE/EHT variant 601 (i.e., “11”), four bits (i.e., B2 to B5) for a control ID 602 to indicate a UHR LA with expansion type for the control information 200 (e.g., 1101), and the control information 200. The UHR LA without expansion type may be indicated when expansion is not needed for providing all the UHR LA parameters between a first network device and a second network device. In contrast, the UHR LA with expansion type may be indicated when expansion is needed for providing all the UHR LA parameters between a first network device and a second network device. As discussed in relation to FIG. 3, the need for the UHR LA expansion may depend on whether particular UHR LA parameters need to be sent (i.e., pre-designated UHR LA expansion parameters). As shown in FIGS. 6A and 6B, the respective control IDs 602 may correspond to values that differ by only one bit (i.e., bit B5). In FIG. 6B, at least one bit of the control information 200, such as the first m bits (where m is a natural number), may be used to indicate a sub-type for the UHR LA expansion. In this case, the remaining 26-m bits may be used to indicate UHR LA parameters.

In some embodiments wherein a UHR LA expansion is needed, a first PPDU may have its respective control ID 602 set to indicate a UHR LA with expansion type, as described in relation to FIG. 6B, and a subsequent, second PPDU may have its respective control ID 602 set to indicate a UHR LA expansion type. The control ID 602 of each of the first PPDU and the second PPDU may correspond to a same value (e.g., 13 or “1101”). Here, the control information 200 of the first PPDU and the second PPDU may be respectively configured to have a format as described in relation to FIGS. 5A and 5B. Alternatively, the control ID 602 of each of the first PPDU and the second PPDU may correspond to a different respective value (e.g., 13 and 15, respectively). If the control ID 602 of the second PPDU, which may also be configured to have a format as described in relation to FIG. 6B, is set to 15, at least one bit of the control information 200, such as the first m bits (where m is a natural number), may be used to indicate a sub-type for the UHR LA expansion. In this case, the remaining 26-m bits may be used to indicate UHR LA parameters.

Embodiments of the present disclosure may further be directed towards providing a method for reporting unavailability from a first network device to a second network device of a Wi-Fi communication network. In these embodiments, a PPDU prepared by the first network device, as described in relation to action 301 of FIG. 3, may have its control ID 602 set to indicate, for the control information 200, an unavailability report type. Each of one or more groups of bits from among the respective plurality of bits of the control information 200 may be set to indicate a respective unavailability parameter, such as an availability start time and/or an unavailability duration. The unavailability report type may be assigned to a control ID 602 having a value, for example, among 11 to 14 and may further be different those values assigned to, for example, the UHR LA type and the UHR LA extension type.

Embodiments of the present disclosure may be implemented using electronics hardware, software, or a combination thereof. In some embodiments, the invention may be implemented by one or multiple computer processors executing program instructions stored in memory. In some embodiments, the invention may be implemented partially or fully in hardware, for example using one or more field programmable gate arrays (FPGAs) or application specific integrated circuits (ASICs) to rapidly perform processing operations.

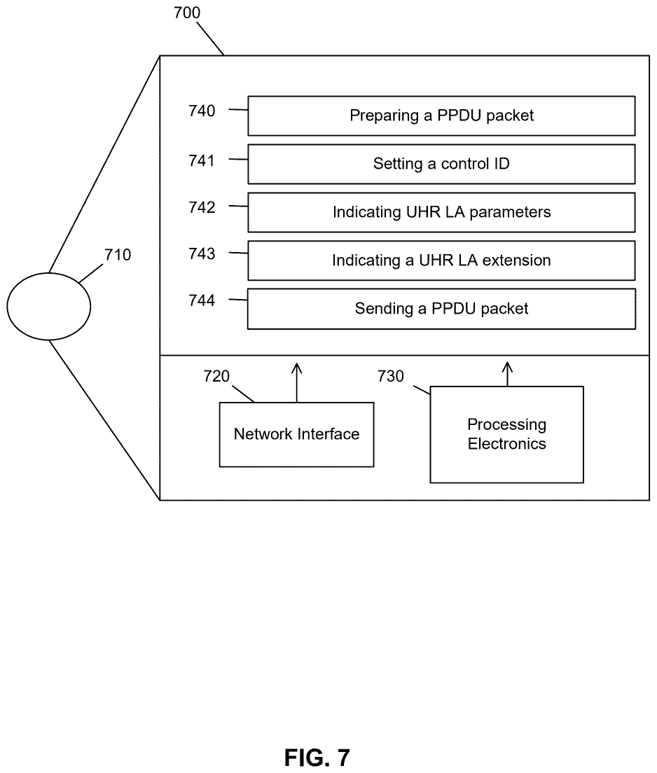

FIG. 7 shows an apparatus 700 for UHR LA, according to embodiments of the present disclosure. The apparatus 700 may be located at a node 710 of a network, such as a Wi-Fi communication network. The apparatus 700 may include a network interface 720 and processing electronics 730. The processing electronics 730 may include a computer processor executing program instructions stored in memory, or other electronics components such as digital circuitry, including for example FPGAs and ASICs. The network interface 720 may include an optical communication interface or radio communication interface, such as a transmitter and receiver. The apparatus 700 may include several functional components, each of which may be partially or fully implemented using the underlying network interface 720 and processing electronics 730. Examples of functional components may include modules for preparing 740 a PPDU packet, setting 741 a control ID, indicating 742 UHR LA parameters, indicating 743 a UHR LA extension, and sending 744 a PPDU packet.

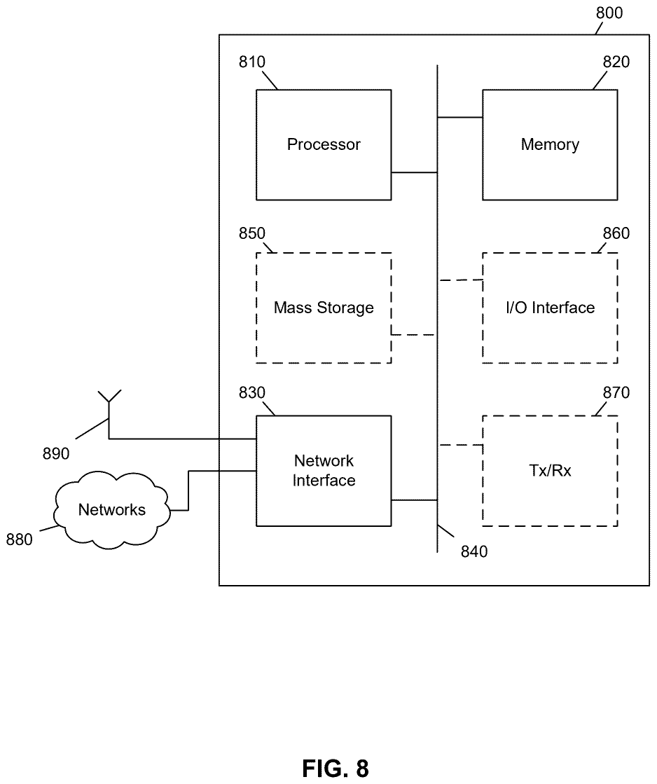

FIG. 8 shows a schematic diagram of an electronic device 800 that may perform any or all of the operations of the above methods and features explicitly or implicitly described herein, according to different embodiments of the present disclosure. For example, a computer equipped with network function may be configured as electronic device 800. The electronic device 800 may be used to implement the apparatus 700 of FIG. 7, for example. The electronic device 800 may further be used as part of a network device of a Wi-Fi communication network, for example.

As shown, the electronic device 800 may include a processor 810, such as a Central Processing Unit (CPU) or specialized processors such as a Graphics Processing Unit (GPU) or other such processor unit, memory 820, network interface 830, and a bi-directional bus 840 to communicatively couple the components of electronic device 800. Electronic device 800 may also optionally include non-transitory mass storage 850, an I/O interface 860, and a transceiver 870. According to certain embodiments, any or all of the depicted elements may be utilized, or only a subset of the elements. Further, the electronic device 800 may contain multiple instances of certain elements, such as multiple processors, memories, or transceivers. Also, elements of the hardware device may be directly coupled to other elements without the bi-directional bus 840. Additionally or alternatively to a processor and memory, other electronics, such as integrated circuits, may be employed for performing the required logical operations.

The memory 820 may include any type of tangible, non-transitory memory such as static random access memory (SRAM), dynamic random access memory (DRAM), synchronous DRAM (SDRAM), read-only memory (ROM), any combination of such, or the like. The mass storage element 850 may include any type of tangible, non-transitory storage device, such as a solid state drive, hard disk drive, a magnetic disk drive, an optical disk drive, USB drive, or any computer program product configured to store data and machine executable program code. According to certain embodiments, the memory 820 or mass storage 850 may have recorded thereon statements and instructions executable by the processor 810 for performing any of the aforementioned method operations described above.

Network interface 830 may include at least one of a wired network interface and a wireless network interface. The network interface 830 may include a wired network interface to connect to a communication network 880 and may also include a radio access network interface 890 for connecting to the communication network 880 or other network elements over a radio link. The network interface 830 enables the electronic device 800 to communicate with remote entities such as those connected to the communication network 880.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise. The phrase “at least one” means one or more, and “a plurality of” means two or more. In addition, “and/or” describes an association relationship of associated objects, and indicates that there may be three relationships. For example, A and/or B may indicate cases including “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent “a”, “b”, “c”, “a and b”, “a and c”, “b and c”, or “a, b and c”, where a, b, and c may be a single or multiple form.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method for providing ultra-high reliability link adaptation (ULA) parameters from a first network device to a second network device in an IEEE 802.11 wireless communication network, the method comprising, at the first network device:
preparing a physical protocol data unit (PPDU) having a medium access control (MAC) header including a high-throughput (HT) control field, the HT control field including a control subfield providing a control identifier (ID) and control information, each of the control ID and control information including a respective plurality of bits;
setting the respective plurality of bits of the control ID to indicate, for the control information, a ULA type;
setting five consecutive bits from among the respective plurality of bits of the control information to indicate an ultra-high reliability modulation and coding system;
and
sending, through the wireless communication network, the PPDU to the second network device.

2. The method of claim 1 wherein the respective plurality of bits of the control ID consists of four bits and is set to one of 1011, 1100, 1101, and 1110.

3. The method of claim 1 wherein:
the respective plurality of bits of the control information consists of 26 bits;
and
the method further comprises, at the first network device:
setting, from among the 26 bits of the control information:
a first one bit to indicate an unsolicited management frame block (MFB);
a second one bit to indicate a management request/uplink extremely high throughput trigger-based PPDU MFB;
a first three bits to indicate a number of spatial streams;
eight bits to indicate a resource unit allocation;
a third one bit to indicate a primary/secondary 160 MHz channel;
a second three bits to indicate a bandwidth;
a third three bits to indicate one or more MAC sequence control information/partial PPDU parameters;
and
a fourth one bit to indicate transmission beamforming.

4. The method of claim 1 wherein:
the respective plurality of bits of the control ID is set to indicate, for the control information, the ULA type and to further indicate a subsequent ULA expansion;
the method further comprises, at the first network device:
preparing a further PPDU having a further MAC header including a further HT control field, the further HT control field including a further control subfield providing a further control ID and further control information, each of the further control ID and further control information including a respective plurality of bits;
setting the respective plurality of bits of the further control ID to indicate, for the further control information, a ULA expansion type;
setting each of one or more groups of bits from among the respective plurality of bits of the further control information to indicate a respective further ULA parameter;
and
sending, through the wireless communication network, the further PPDU to the second network device.

5. The method of claim 4 wherein each of the ULA type and the ULA expansion type correspond to a same value.

6. The method of claim 4 wherein each of the ULA type and the ULA expansion type correspond to different respective values.

7. The method of claim 4 wherein the method further comprises, at the first network device:
setting, for the PPDU, at least one bit from among the respective plurality of bits of the control information to indicate that the control information is initial control information;
and
setting, for the further PPDU, at least one bit from among the respective plurality of bits of the further control information to indicate that the further control information is subsequent control information.

8. The method of claim 4 wherein each at least one further ULA parameter is one of:
an unequal modulation (UEQM) indicator;
a UEQM pattern;
a distributed resource unit indicator;
a distribution bandwidth;
a number of spatial streams for multi-user multiple input multiple output (MU-MIMO) operation;
and
a modulation and coding system for MU-MIMO.

9. The method of claim 4 further comprising, at the first network device:
setting, for the further PPDU, at least one bit from among the respective plurality of bits of the further control information to indicate, for the further control information, a ULA expansion sub-type.

10. A method for providing ultra-high reliability link adaptation (ULA) parameters from a first network device to a second network device in an IEEE 802.11 wireless communication network, the method comprising, at the first network device:
preparing a first physical protocol data unit (PPDU) and a second PPDU each having a respective medium access control (MAC) header including a respective high-throughput (HT) control field, each HT control field including a respective control subfield providing a respective control identifier (ID) and respective control information, each control ID and each control information including a respective plurality of bits;
setting, for the first PPDU, the respective plurality of bits of the respective control ID to indicate, for the respective control information, a ULA type and to further indicate a ULA expansion;
setting, for the second PPDU, the respective plurality of bits of the respective control ID to indicate, for the respective control information, a ULA expansion type;
setting, for each of the first PPDU and the second PPDU, each of one or more groups of bits from among the respective plurality of bits of the respective control information to indicate a respective ULA parameter;
and
sending, through the wireless communication network, the first PPDU and the second PPDU to the second network device.

11. The method of claim 10 wherein each of the ULA type and the ULA expansion type correspond to a same value.

12. The method of claim 10 wherein each of the ULA type and the ULA expansion type correspond to different respective values.

13. The method of claim 10 further comprising, at the first network device:
setting, for the PPDU, at least one bit from among the respective plurality of bits of the control information to indicate that the control information is initial control information;
and
setting, for the further PPDU, at least one bit from among the respective plurality of bits of the further control information to indicate that the further control information is subsequent control information.

14. The method of claim 10 wherein each at least one further ULA parameter is one of:
an unequal modulation (UEQM) indicator;
a UEQM pattern;
a distributed resource unit indicator;
a distribution bandwidth;
a number of spatial streams for multi-user multiple input multiple output (MU-MIMO) operation;
and
a modulation and coding system for MU-MIMO.

15. The method of claim 10 further comprising, at the first network device:
setting, for the further PPDU, at least one bit from among the respective plurality of bits of the further control information to indicate, for the further control information, a ULA expansion sub-type.

16. A method for providing one or more ultra-high reliability link adaptation (ULA) parameters from a first network device to a second network device in an IEEE 802.11 wireless communication network, the method comprising, at the first network device:
preparing a physical protocol data unit (PPDU) having a medium access control (MAC) header including a high-throughput (HT) control field, the HT control field including a control subfield providing a control identifier (ID) and control information, each of the control ID and control information including a respective plurality of bits;
performing a first set of actions when the one or more ULA parameters excludes each of one or more ULA expansion parameters, the first set of actions including:
setting the respective plurality of bits of the control ID to indicate, for the control information, a ULA without expansion type;
setting at least one bit from among the respective plurality of bits of the control information to indicate the one or more ULA parameters;
and
sending, through the wireless communication network, the PPDU to the second network device;
and
performing a second set of action when the one or more ULA parameters includes at least one of the one or more ULA expansion parameters, the second set of actions including:
preparing a further PPDU having a further MAC header including a further HT control field, the further HT control field including a further control subfield providing a further control ID and further control information, each of the further control ID and further control information including a respective plurality of bits;
setting:
the respective plurality of bits of the control ID to indicate, for the control information, a ULA with expansion type,
and
the respective plurality of bits of the further control ID to indicate, for the further control information, a ULA expansion type;
setting at least one bit of each of the respective plurality of bits of the control information and the further control to indicate the one or more ULA parameters;
and
sending, through the wireless communication network, the PPDU and the further PPDU to the second network device.

17. The method of claim 16 wherein the one or more ULA expansion parameters includes at least one of an unequal modulation parameter and a distributed resource unit parameter.

18. The method of claim 16 wherein each of the ULA with expansion type and the ULA without expansion type correspond to a different respective value.

19. The method of claim 18 wherein each of the ULA without expansion type and the ULA expansion type correspond to a different respective value.

20. The method of claim 16 wherein the respective plurality of bits of the control ID and the respective plurality of bits of the further control ID differ by only one bit.
